(19) United States
(12) Patent Application Publication
(10) Pub. No.: US 2009/0090447 A1
(43) Pub. Date: Apr. 9, 2009

(54) TIRE CORD REINFORCEMENT

(76) Inventors: Donald William Baldwin, JR., Perrysburg, OH (US); Robert John Gartland, Austintown, OH (US); Walter Kevin Westgate, Uniontown, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/199,821

(22) Filed: Aug. 28, 2008

Related U.S. Application Data
(60) Provisional application No. 60/977,682, filed on Oct. 5, 2007.

(51) Int. Cl. B60C 9/00

(52) U.S. Cl. 152/451

(57) ABSTRACT

A composite cable is disclosed suitable for use as a reinforcement in an aircraft tire. The cable is formed of an aramid yarn and a nylon yarn cabled together, wherein the aramid yarn has a linear density in the range of about 220 to about 3300 dtex, and the nylon yarn has a linear density in the range of about 220 to about 2100 dtex.

This application claims the benefit of, and incorporates by reference, U.S. Provisional Application No. 60/977,682 filed Oct. 5, 2007.

### FIELD OF THE INVENTION

This invention relates to a composite of a plurality of dissimilar individual textile yarns cabled together as plies to form a cord. The invention particularly relates to a pneumatic tire containing a cord reinforcement of such cabled textile yarns, and even more particularly to heavy load tires such as aircraft tires.

### BACKGROUND OF THE INVENTION

Compared to other applications such as passenger tires or heavy duty equipment tires, aircraft tires undergo extremely severe operating conditions. This is due to the high speeds of aircraft tires as well as the heavy loading. Aircraft tires are often heavy in order to be able to withstand extreme loads under severe operating conditions. Reducing overall weight of the aircraft is desired for increased performance and functionality. Thus, a reduced weight tire which is capable of the extreme operating environment is desired.

The load carrying members or carcass reinforcements of bias aircraft tires generally comprise multiple angled plies of textile cords, typically on the order of 10 or more, which are anchored in each bead. One way to reduce tire weight is to utilize stronger tire reinforcements. Traditional bias aircraft tires have been manufactured using polyamide 6 or polyamide 6/6 fibers (Nylon 6, Nylon 6/6) which are made up of long polyamide chains. The attributes of nylon can provide a multitude of linear densities to satisfy given tire requirements. Nylon has excellent ductility which can translate into fatigue resistance, which is required in aircraft applications due to the amount of tire cyclic deformation.

Another type of reinforcement is aramid fibers. Aramid reinforcement is made up of long polyamide chains similar to nylon. Aramid fibers have very high strength compared to Nylon, but intrinsically poorer ductility. Nylon has superior durability performance (applied cyclic tension—compression loading) versus aramid.

The modern trend in aircraft tires is to utilize merged, hybrid or composite reinforcement cord made of two or more types of materials such as nylon or aramid. Hybrid tire cords greatly expand the range of tire cord properties attainable. However, it is very difficult to design an aircraft tire that is made of composite cords and meet all the stringent design requirements: high strength, durability, ability to tolerate thermal loading and ductility. Further, aircraft bias tires are very difficult to model due to the complexity of the design. Still further yet, in order to meet the strength requirements, the tire usually ends up being heavier. Thus an improved aircraft tire is needed, which is capable of meeting high speed, high load and with reduced weight.

### Definitions

The following definitions are controlling for the disclosed invention.

“Aramid” and “aromatic polyamide” are manufactured fibers in which the fiber-forming substance is generally recognized as a long chain synthetic aromatic polyamide in which at least 85% of the amide linkages are attached directly to the two aromatic rings. Representative of an aramid or aromatic polyamide is a poly (p-phenyleneterephtalamide).

“Apex” means an elastomeric filler located radially above the bead core and between the plies and the turnup ply.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Bias tire” (cross ply) means a tire in which the reinforcing cords in the carcass ply extend diagonally across the tire from bead to bead at about a 25°-65° angle with respect to equatorial plane of the tire. If multiple plies are present, the ply cords run at opposite angles in alternating layers.

“Cable” means a cord formed by twisting together two or more plied yarns.

“Carcass” means the tire structure apart from the belt structure, tread, undertread, and sidewall rubber over the plies, but including the beads.

“Chafers” refers to narrow strips of material placed around the outside of the bead to protect cord plies from the rim, distribute flexing above the rim, and to seal the tire.

“Chippers” means a reinforcement structure located in the bead portion of the tire.

“Circumferential” means lines or directions extending along the perimeter of the surface of the annular tire parallel to the Equatorial Plane (EP) and perpendicular to the axial direction.

“Cord” means one of the reinforcement strands of which the plies of the tire are comprised.

“Cord angle” means the acute angle, left or right in a plan view of the tire, formed by a cord with respect to the equatorial plane. The “cord angle” is measured in a cured but uninflated tire.

“Denier” means the weight in grams per 9000 meters (unit for expressing linear density).

“Dtex” means the weight in grams per 10,000 meters.

“Elastomer” means a resilient material capable of recovering size and shape after deformation.

“Equatorial plane (EP)” means the plane perpendicular to the tire's axis of rotation and passing through the center of its tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments, characterized by having a length at least 100 times its diameter or width.

“Filament count” means the number of filaments that make up a yarn. Example: 1000 denier polyester has approximately 190 filaments.

“Flipper” means a reinforced fabric wrapped about the bead core.

“Greige” means unfinished cord or fabric.

“Inner” means toward the inside of the tire and “outer” means toward its exterior.

“Innerliner” means the layer or layers of elastomer or other material that form the inside surface of a tubeless tire and that contain the inflating fluid within the tire.

“LASE” is load at specified elongation.

“Lateral” means an axial direction.

“Lay length” means the distance at which a twisted filament or strand travels to make a 360° rotation about another filament or strand.

Nylon is understood to be an aliphatic polyamide 6.6, 6 or 4.6.

“Ply” means a continuous layer of rubber-coated parallel cords in the context of a tire and also means a twisted yarn in a context of a yarn or a cord as used herein the meaning is dependant on the context.

“Polyester” means any polymer synthesized from the polycondensation of a diol and a dicarboxylic acid.

“Radial” and “radially” are used to mean directions radially toward or away from the axis of rotation of the tire.

“Radial-ply tire” means a belted or circumferentially-restricted pneumatic tire in which the ply cords which extend from bead to bead are laid at cord angles between 65° and 90° with respect to the equatorial plane of the tire.

“Section height (SH)” means the radial distance from the nominal rim diameter of the tire at its equatorial plane.

“Sidewall” means that portion of a tire between the tread and the bead.

“Tenacity” is stress expressed as force per unit linear density of the unstrained specimen (gm/tex or gm/denier).

“Tensile” is stress expressed in forces/cross-sectional area. Strength in psi=12,800 times specific gravity times tenacity in grams per denier.

“Tread” means a molded rubber component which, when bonded to a tire casing, includes that portion of the tire that comes into contact with the road when the tire is normally inflated and under normal load.

“Twisted” means the number of turns about its axis per unit of length of a yarn, turns per inch being TPI.

“Yarn” occurs in the following forms: 1) a number of fibers twisted together; 2) a number of filaments laid together without twist; 3) a number of filaments laid together with a degree of twist; 4) a single filament with or without twist (monofilament); 5) a narrow strip of material with or without twist.

“Zigzag belt reinforcing structure” means at least two layers of cords or a ribbon of parallel cords having 1 to 20 cords in each ribbon and laid up in an alternating pattern extending at an angle between 5° and 30° between lateral edges of the belt layers.

### BRIEF DESCRIPTION OF THE DRAWINGS

The invention will be described by way of example and with reference to the accompanying drawings in which:

FIG. 1 is a schematic view of a cord construction of the invention

FIG. 2 is a plot of load vs. percent elongation for the cord construction of the invention;

FIG. 3 is a plot of break strength vs. # of cycles for the cord construction of the invention;

FIG. 4 is a plot of tenacity vs. # of cycles for the cord construction of the invention;

FIG. 5 is a bar chart illustrating the greige and dipped break strength for Nylon, aramid, and the cord construction of the invention;

FIG. 6 is a bar chart illustrating the tenacity for Nylon, aramid, and the cord construction (dipped) of the invention;

FIG. 7 is a bar chart illustrating the % elongation for Nylon, aramid, and the cord construction (dipped) of the invention;

FIG. 8 is a bar chart illustrating the energy to break characteristics for Nylon, aramid, and the cord construction (dipped) of the invention;

FIG. 9 is a bar chart illustrating the toughness characteristics for Nylon, aramid, and the cord construction (dipped) of the invention;

FIG. 10 is a bar chart illustrating the shrinkage (%) characteristics for Nylon, aramid, and the cord construction (dipped) of the invention;

FIG. 11 is a bar chart illustrating the dynamic break strength characteristics after 4 hours (flexed break strength, unflexed break strength, and retained break strength) for Nylon, aramid, and the cord construction of the invention;

FIG. 12 is a bar chart illustrating the dynamic break strength characteristics (flexed break strength, unflexed break strength, and retained break strength) after 8 hours for Nylon, aramid, and the cord construction of the invention; and

FIG. 13 is a cross section of an exemplary aircraft tire of the present invention; and

FIG. 14 is a chart illustrating dynamic fatigue resistance vs. number of cycles.

### DETAILED DESCRIPTION OF THE INVENTION

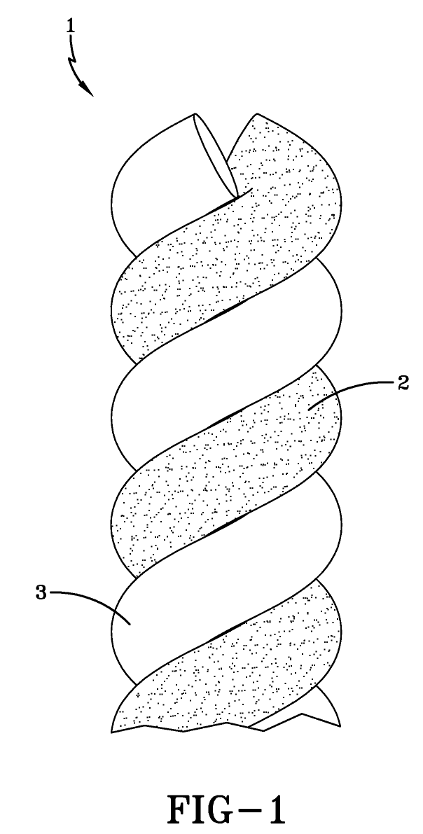

FIG. 1 illustrates a first embodiment of a cord construction of the invention. The cord is comprised of helically cabled dissimilar yarns 2 and 3. The composite or hybrid cord is comprised of one or more yarns of an aramid 3, and more preferably, only a single yarn. The aramid 3 may comprise what is known to those skilled in the art as standard aramid. One example of an aramid suitable for the invention is made by Dupont and sold under the trade name Kevlar 29. Another example of a standard aramid suitable for the invention is manufactured by Teijin and sold under the trade name Twaron 1000. The linear density may range from about 220 dtex to about 3300 dtex, more preferably from about 1100 to about 3300, and most preferably about 1670 dtex. Each aramid yarn is individually twisted in the Z direction. The twist may range from about 3 to about 16 tpi (twists/inch) in the Z direction, and more preferably about 6 to about 12 tpi, and most preferably to about 10.7 tpi in the Z direction.

The composite cord further comprises an aliphatic polyamide or nylon yarn 2, preferably nylon 6/6. Preferably only a single yarn of nylon is used. The nylon preferably has a linear density in the range of about of 220 to about 2100 dtex (1890 denier), more preferably from about 1400 to about 2100, and most preferably about 1400 dtex. The nylon 2 is individually twisted by a Z twist in the range of about 3 to about 16, more preferably from about 3 to about 7, and most preferably about 6.2 (tpi). The nylon and aramid yarns are then plied together to form a cable with an S twist in the range of about 3 to about 16 tpi, more particularly in the range of about 7 to about 10, and most preferably about 9.7 twists/inch.

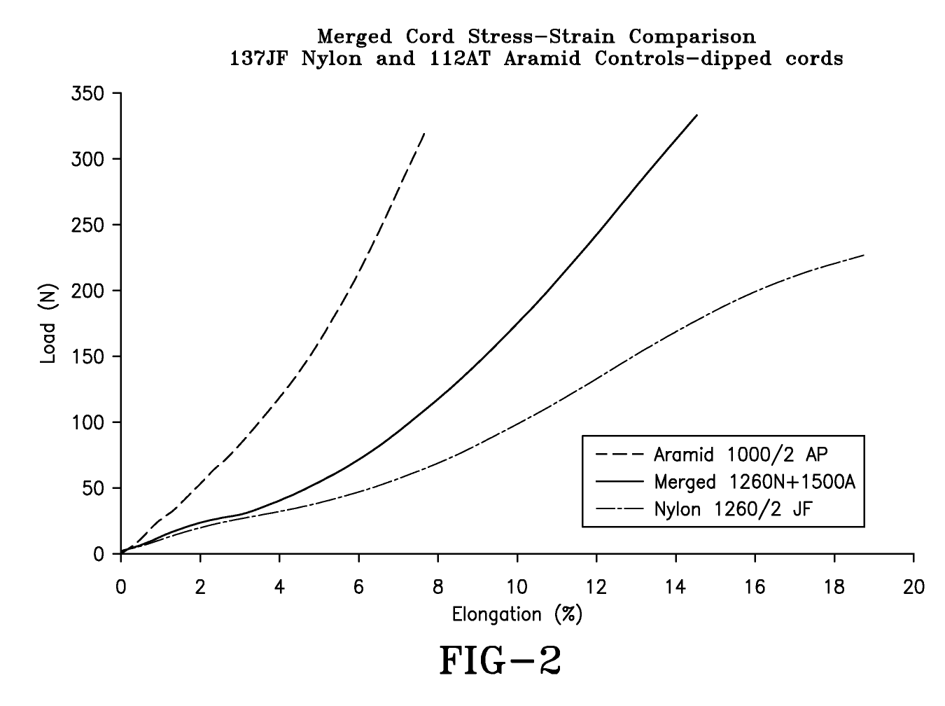

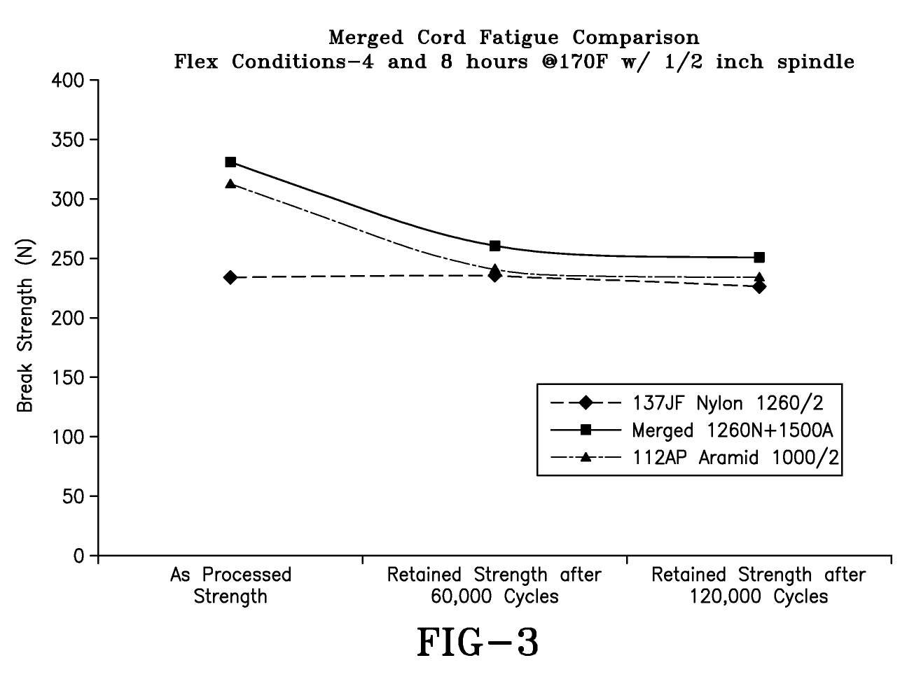

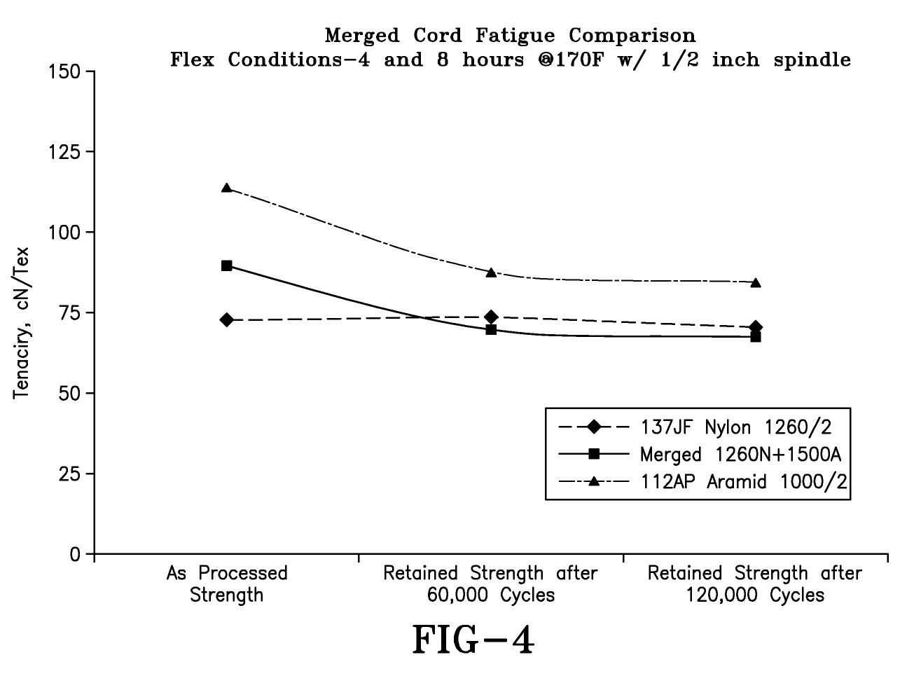

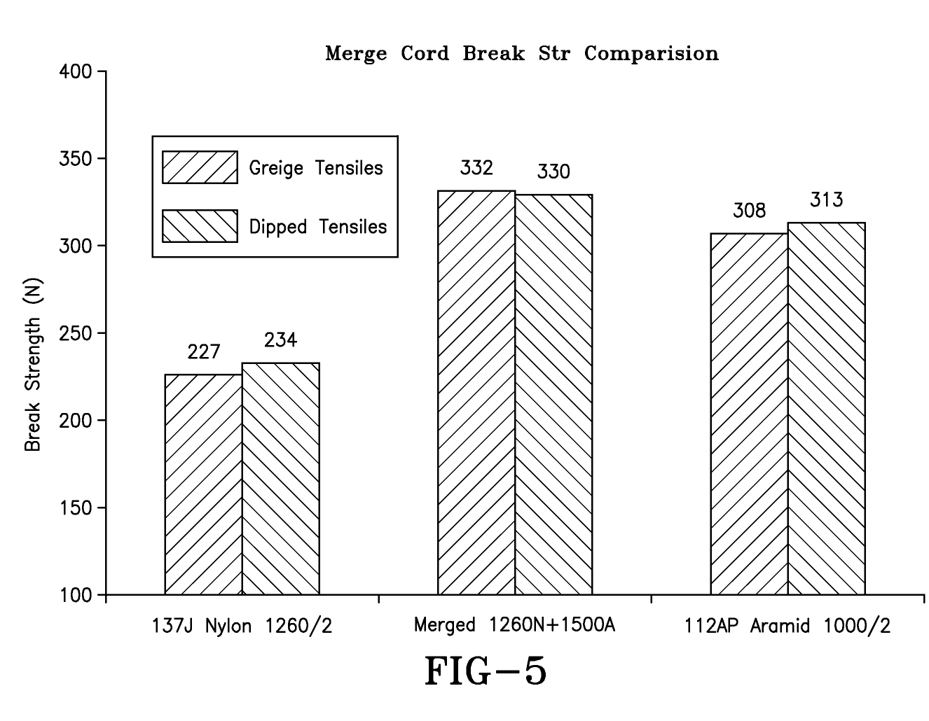

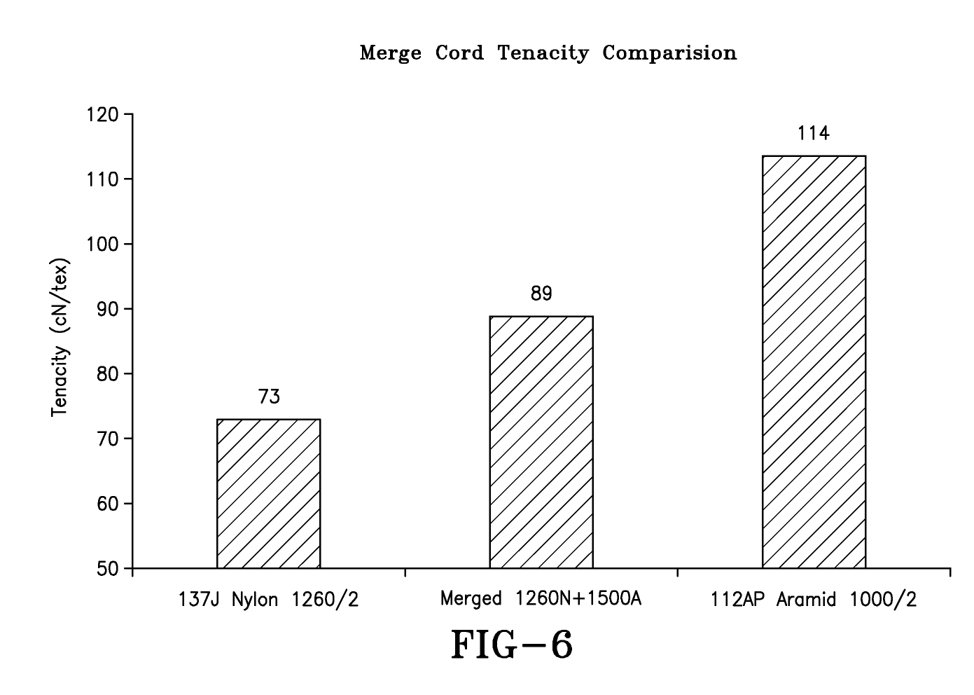

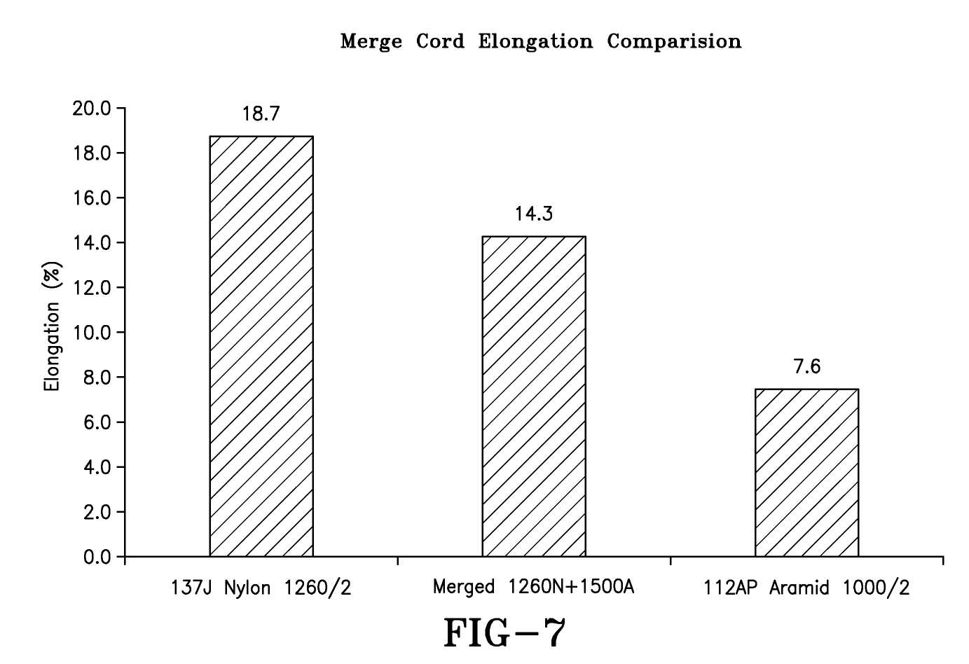

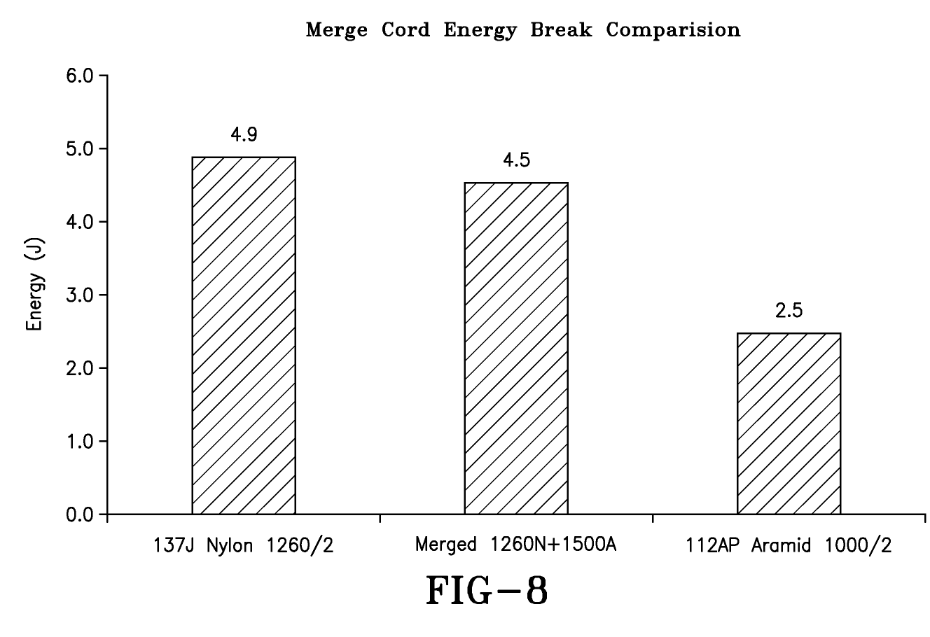

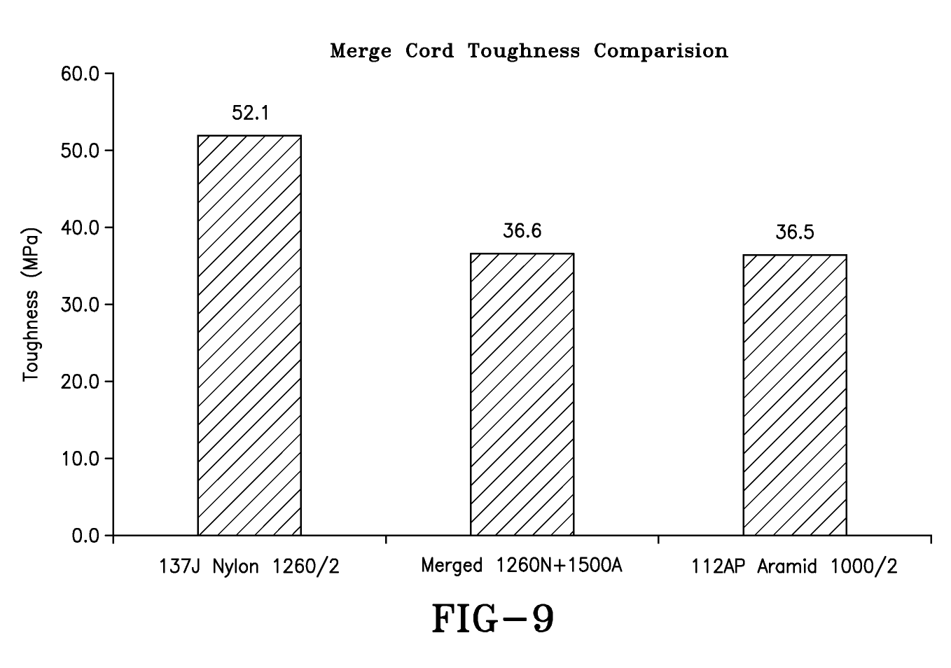

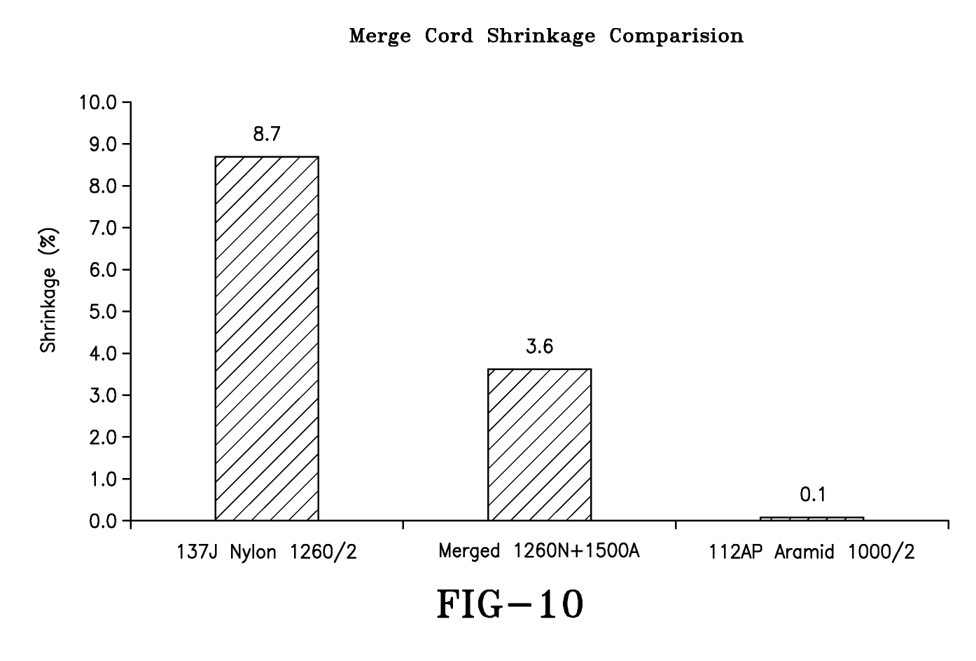

Table I illustrates the cord properties of the first embodiment both greige and dipped in an RLF bath. Table I also illustrates for comparison, a 1400/1/2 Nylon construction and an Aramid 1100/1/2 construction. As shown in the Table and FIG. 5, the 1400N+1670A construction had greatly improved break strength for both greige and dipped. The cord construction had a 45% increase in break strength over nylon and a 5% increase over the aramid. FIG. 3 illustrate the change in break strength versus number of cycles, and shows that the break strength of the invention always remains greater than either the nylon or the aramid. FIG. 2 illustrates the stress strain curve for the dipped cord construction of the invention and nylon and aramid. The dipped construction of the invention has greater area under the curve as compared to the aramid construction, and performed equally as well as the nylon construction. FIG. 7 illustrates the elongation at break, wherein the cord of the invention shows a 24% decrease in elongation compared to nylon. FIG. 8 illustrates the energy to break, wherein the cord of the invention has similar energy to break characteristics of nylon. FIG. 6 illustrates tenacity, wherein the cord of the invention has a 25% increase in tenacity over nylon. FIG. 4 illustrates the tenacity over 120,000 cycles, and illustrates the tenacity slightly decreases, then levels out. FIG. 9 illustrates toughness for the cord of the invention, and shows the cord of the invention has the toughness characteristics of aramid. FIG. 10 illustrates the shrinkage characteristics of the invention, and illustrates a 58% decrease in shrinkage as compared to nylon.

TABLE I
Dipped and Greige Cable Physical Properties

| | Cable | | |
|---|---|---|---|
| | 1400 N + 1670 A | Nylon | Aramid |
| | 6.2 N − 10.7 A/9.7 | 1400/1/2 | 1100/1/2 |
| Greige Tensile | | | |
| LASE 5% (N) | 31.8 | 23.6 | 86 |
| Break load (N) | 332 | 227 | 308 |
| Elongation@Break | 16.4 | 24.3 | 9.8 |
| (%) | | | |
| W to B | 2722 | 2758 | 1509 |
| Dipped Tensiles | | | |
| LASE 5% (N) | 54.6 | 38.5 | 162.6 |
| Break load (N) | 330 | 234 | 313 |
| Elong. @ Break | 14.3 | 18.7 | 7.6 |
| (%) | | | |
| Denier | 3715 | 3188 | 2736 |
| Gauge, mils | 27 | 26 | 21 |
| Tenacity (cN/tex) | 90 | 73 | 115 |

Table II illustrates the cord properties of the present invention for dynamic conditions.

| Dynamic tensiles | 1260N + 1500 A | 1260/2 Nylon | 1000/2 Aramid |
|---|---|---|---|
| Break strength (N) | | | |
| 4 hr. unflexed | 335.2 | 234.1 | 314.7 |
| 4 hr. flexed | 261 | 236.2 | 240.9 |
| % retained | 78 | 100 | 77 |
| 18 @ 310 F. | | | |
| 8 hrs. unflexed | 335.2 | 234.1 | 314.7 |
| 8 hrs. flexed | 250.7 | 227.2 | 234.9 |
| % retained | 75 | 97 | 75 |

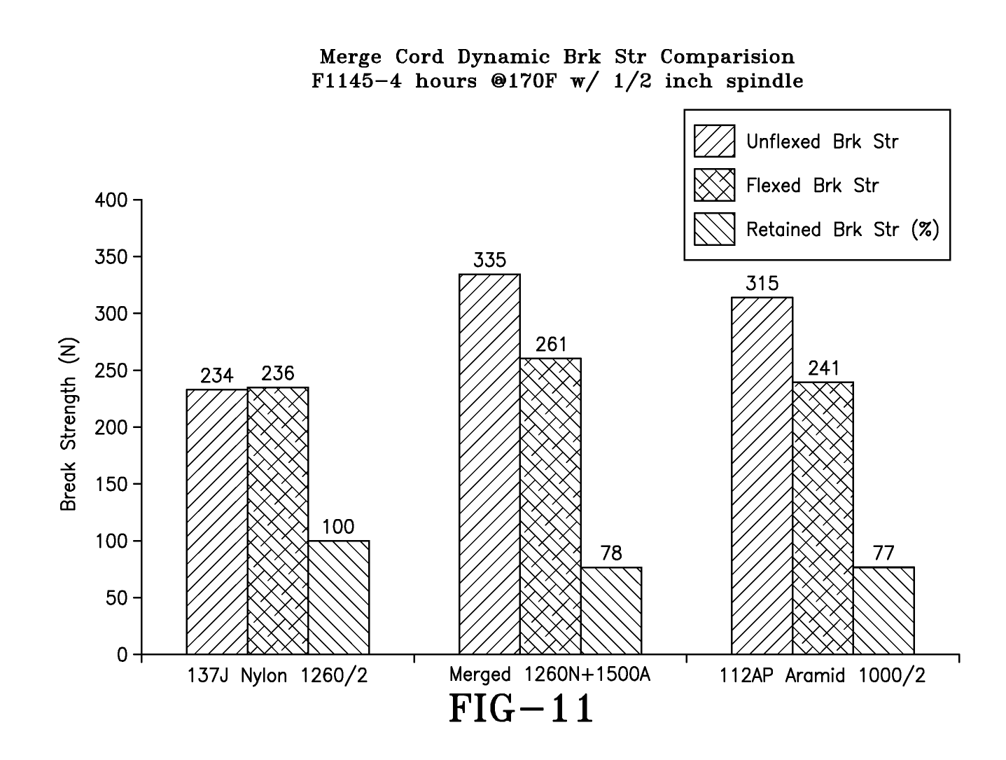

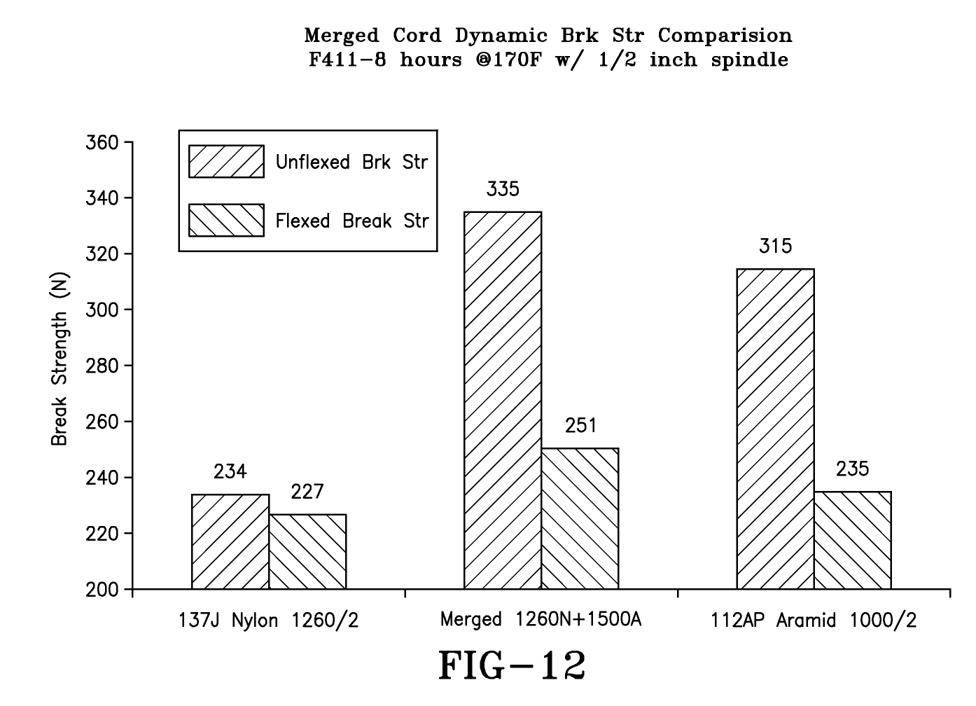

Table II indicates the cord properties of the present invention for dynamic conditions. The break strength of the invention for either the flexed or unflexed condition is greater than either the nylon or aramid values. The test was conducted at 4 hours at 170 F using a ½ inch spindle. As shown in FIG. 11, the cord of the invention maintained a 10% increase in flexed break strength over the 1260 Nylon, after flexing. FIG. 12 illustrates the dynamic break strength for both the flexed and unflexed condition, taken after 8 hours at 170 F with ½ inch spindle (F411 standard). As shown, the cord of the invention maintained a 10% increase in break strength over nylon, after flexing.

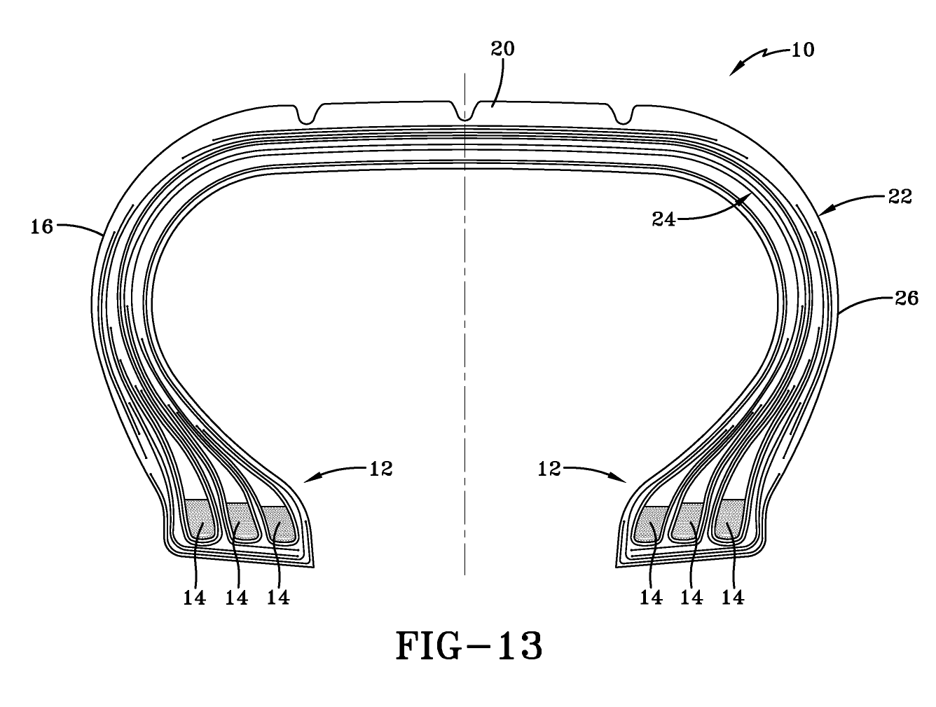

FIG. 13 illustrates an aircraft tire 10. Although a bias tire is shown, the aircraft tire could also be radial. The aircraft tire comprises a pair of beads wherein each bead is split into three bead portions 12 each containing a bead core 14 embedded therein. The aircraft tire comprises a sidewall portion 16 extending substantially outward from each of the bead portions 12 in the radial direction of the tire, and a tread portion 20 of substantially cylindrical shape extending between radially outer ends of these sidewall portions 16. Furthermore, the tire 10 is reinforced with a carcass 22 toroidally extending from one of the bead portions 12 to the other bead portion 12. The carcass 22 is comprised of inner carcass plies 24 and outer carcass plies 26. The inner and outer carcass plies are wrapped in a desired configuration, such as shown for example in FIG. 13. The use of the invention is not limited to this configuration, as there are many alternate configurations. One or more of the carcass plies 24, 26 may also comprise an aramid and nylon hybrid cord 1 of the invention, as described above.

The aircraft tire 10 further comprises a belt package 40 arranged between the carcass 22 and the tread rubber 28. The belt package further comprises a plurality of belts, one or more of the belts may be comprised of an aramid and nylon cord of the invention, as described in detail, above.

### EXAMPLE 1

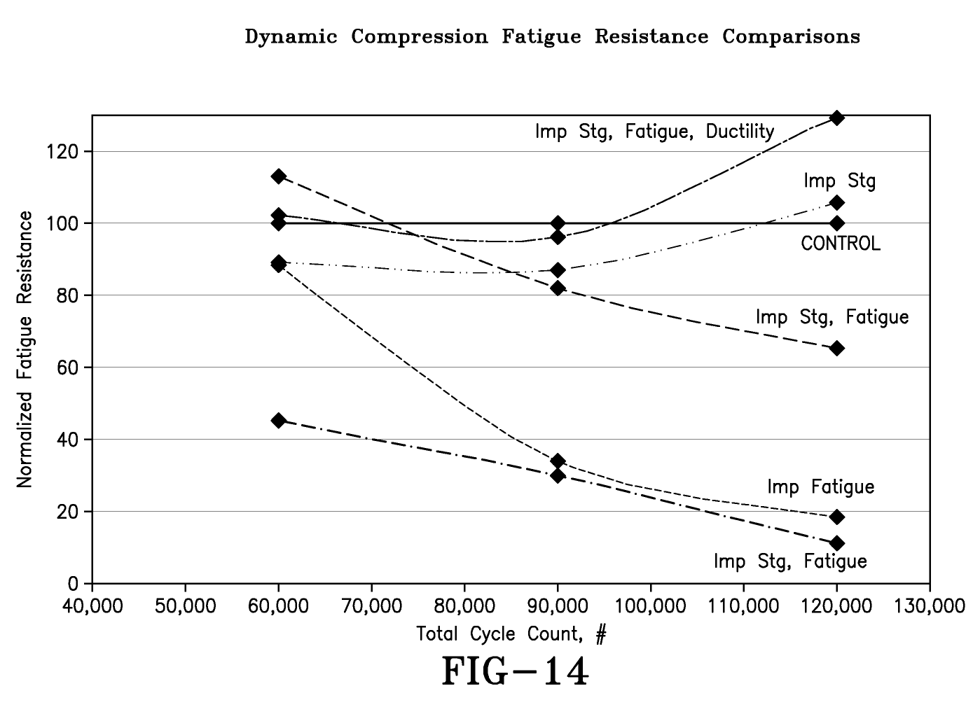

Two test tires 32×11.5-15 of the tire construction shown in FIG. 13 were built and tested. The control tire comprised a nylon carcass. The test tire comprised a merged cord construction of 1670 dtex (A)+1400 dtex (N)/½; 10.7Z(A)+6.2Z(N)×9.7 S. The tires were subjected to a series of tests. The tires were subjected to a burst test. The nylon control tire burst at 1524 psi. The test tire burst at 1176 psi. The tires were also subjected to dynamic testing. The test tire passed 48 normal takeoffs, 1 extended taxi and 1 high speed takeoff before failing. The test tire also passed diffusion testing. The dynamic tire performance data of the invention exceeded expectations and were quite surprising. Dynamic fatigue resistance of the invention is shown in FIG. 14 and illustrated improved strength, fatigue and ductility over the nylon control. Although the tire of the invention did not test at the levels desired for commercialization, the tests demonstrated the viability of the concept.

Variations of the present invention are possible in light of the description as provided herein. While certain representative embodiments and details have been shown for the purpose of illustrating the subject inventions, it will be apparent to those skilled in the art that various changes and modifications can be made without departing from the scope of the subject inventions.

What is claimed is:

1. A cable comprising: a single aramid yarn, and a single nylon yarn cabled together, wherein the aramid yarn has a linear density in the range of about 220 to about 3300 dtex, and the nylon yarn has a linear density in the range of about 220 to about 2100 dtex.

2. The cable of claim 1 wherein the aramid has a linear density of about 1670 dtex.

3. The cable of claim 1 wherein the nylon has a linear density of about 1400 dtex.

4. The cable of claim 1 wherein the overall twist of the cable ranges from about 3 to about 16 tpi.

5. The cable of claim 1 wherein the overall twist of the cable is about 9.7 S.

6. The cable of claim 1 wherein the aramid twist ranges from about 3 to about 16 tpi in the z direction.

7. The cable of claim 1 wherein the aramid twist ranges from about 6 to about 12 tpi in the z direction.

8. The cable of claim 1 wherein the nylon twist ranges from about 3 to about 16 tpi in the z direction.

9. The cable of claim 1 wherein the aramid twist is about 10.72 tpi in the z direction.

10. The cable of claim 1 wherein the nylon twist is about 6.2 tpi in the z direction.

11. The cable of claim 1 wherein the nylon twist ranges from about 3 to about 7 tpi in the z direction.

12. The cable of claim 1 having a cord construction of two aramid yarns having a linear density of about 1670 dtex cabled together with a nylon yarn having a linear density of about 1400 dtex.

13. The cable of claim 1 wherein the nylon yarn has a twist of 10.7 Z, the aramid yarns each have a twist of 6.2Z, and the overall cable has a twist of 9.7 S tpi.

14. A pneumatic rubber tire comprising a carcass and a tread over a road engaging portion of the carcass, wherein the carcass is comprised of one or more cables comprising: a single aramid yarn, and a single nylon yarn cabled together, wherein the aramid yarn has a linear density in the range of about 220 to about 3300 dtex, and the nylon yarn has a linear density in the range of about 220 to about 2100 dtex.
